(19) United States
(12) Patent Application Publication
(10) Pub. No.: US 2006/0147992 A1
(43) Pub. Date: Jul. 6, 2006

(54) Method for detection of bioactive peptides

(76) Inventors: Alexander Ian Smith, Hampton (AU); Michael Berndt, Mount Eliza (AU); Dominic Autelitano, Camberwell (AU); Xavier Csar, Heidelberg (AU); Gert Hoy Talbo, Viewbank (AU)

Correspondence Address: MORGAN LEWIS & BOCKIUS LLP, 1111 PENNSYLVANIA AVENUE NW, WASHINGTON, DC, 20004, US

(21) Appl. No.: 10/520,624

(22) PCT Filed: Jul. 10, 2003
(86) PCT No.: PCT/AU03/00892

§ 371 Date: Jan. 27, 2006

(30) Foreign Application Priority Data
Jul. 10, 2002 (AU) 2002950095
Jul. 1, 2003 (AU) 2003903365

(51) Int. Cl. C40B 40/10

(52) U.S. Cl. 435/7.1

(57) ABSTRACT

A method for the detection of bioactive peptides derived from a precursor protein or protein-containing biological extract, comprising the steps of: (i) providing a library of peptides derived from said precursor protein or protein-containing biological extract; (ii) optionally screening said library to confirm that it includes peptides exhibiting one or more biological activities; (iii) separating said library to provide fractions of the library; (iv) screening said fractions to identify active fractions which include peptides exhibiting said one or more biological activities; (v) optionally separating each said active fraction to provide sub-fractions thereof, and screening said sub-fractions to identify active sub-fractions which include peptides exhibiting said one or more biological activities; and (vi) isolating from said active fractions or active sub-fractions one or more peptides exhibiting said one or more biological activities.

### FIELD OF THE INVENTION

This invention relates to a method for the detection of bioactive peptides. More particularly, the present invention relates to a screening method for the identification of bioactive peptides derived from precursor proteins or protein-containing biological extracts. Such bioactive peptides have potential for use in various therapeutic and/or diagnostic applications, for example, in connection with arterial and venous thrombosis, and cancer.

### GENERAL

Bibliographic details of the publications numerically referred to in this specification are collected at the end of the description. All patents, patent applications, and publications cited herein are incorporated by reference in their entirety.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Those skilled in the art will appreciate that the invention described herein is susceptible to variations and modifications other than those specifically described. It is to be understood that the invention includes all such variations and modifications. The invention also includes all of the steps, features, compositions and compounds referred to or indicated in this specification, individually or collectively, and any and all combinations of any two or more of said steps, features, compositions and compounds.

The present invention is not to be limited in scope by the specific embodiments described herein, which are intended for the purposes of exemplification only. Functionally equivalent products, compositions and methods are clearly within the scope of the invention, as described herein.

### BACKGROUND OF THE INVENTION

The recent sequencing of the human genome has revealed around 30,000 genes, far fewer than would be predicted from the complexity of human biological processes. Alternate splicing of these genes prior to translation would likely generate up to 200,000 primary transcripts, still a long way short of the predicted 1-1.5 million protein/peptide activities present in the human proteome. It is now widely accepted that post translational modifications to the protein products coded by these genes represents the additional level of complexity required, to explain the diversity of function. By way of example, but not limited or restricted to, the most common post- or co-translational event is protease-mediated protein cleavage, either endoprotease or exoprotease, resulting in the generation of smaller protein/peptide bioactivities. These cleavage products possess distinct activities (agonists/antagonists etc.) that can not be identified by analysis of the genetic code.

The present invention is based on a novel technology platform, described as “cryptomics”, which provides a series of integrated procedures that together enable the generation, identification and characterisation of bioactive peptides derived from larger precursor proteins.

The rationale behind the present invention is that controlled proteolytic digestion of naturally occurring proteins with proteases will result in the liberation of cryptic bioactive peptides that ordinarily lie hidden within intact and folded proteins. Accordingly, the present invention includes the systematic generation of peptide (small protein fragments) libraries following treatment with enzymes including but not limited to proteases, oxidases, glycosidases and/or chemical cleavage, of both single proteins and protein containing biological extracts. These modified protein mixtures may be screened for bio-activities of interest preceding their fractionation into libraries from which bioactive moieties are identified by high throughput biological screening assays. Active fractions can then be isolated and fully characterised by classical proteomic technologies prior to activity validation in more sophisticated assay systems. Bioactive peptides thus identified can then be used as biological “leads” including, but not limited to, the generation of potential therapeutics and diagnostics.

### SUMMARY OF THE INVENTION

In one aspect the present invention provides a method for the detection of bioactive peptides derived from a precursor protein or protein-containing biological extract, comprising the steps of:
(i) providing a library of peptides derived from said precursor protein or protein-containing biological extract;
(ii) optionally screening said library to confirm that it includes peptides exhibiting one or more biological activities;
(iii) separating said library to provide fractions of the library;
(iv) screening said fractions to identify active fractions which include peptides exhibiting said one or more biological activities;
(v) optionally separating each said active fraction to provide sub-fractions thereof, and screening said sub-fractions to identify active sub-fractions which include peptides exhibiting said one or more biological activities; and
(vi) isolating from said active fractions or active sub-fractions one or more peptides exhibiting said one or more biological activities.

The term “peptide” as used herein shall be taken to refer to any polymer consisting of amino acids linked by covalent bonds and this term includes within its scope parts or fragments of full length proteins, such as, for example, polypeptides, oligopeptides and shorter peptide sequences consisting of at least 2 amino acids, more particularly at least about 5 amino acid residues. The term “peptide” includes all moieties containing one or more amino acids linked by a peptide bond. In addition, this term includes within its ambit polymers of modified amino acids, including amino acids which have been post-translationally modified, for example by chemical modification including but not restricted to glycosylation, phosphorylation, acetylation and/or sulphation reactions that effectively alter the basic peptide backbone. Accordingly a peptide may be derived from a naturally-occurring protein, and in particular may be derived from a full-length protein by chemical or enzymatic cleavage, using reagents such as CNBr, or proteases such as trypsin or chymotrypsin, amongst others. Alternatively, such peptides may be derived by chemical synthesis using well known peptide synthetic methods.

Also included within the scope of the definition of a “peptide” are amino acid sequence variants (referred to herein as peptide variants). These may contain one or more preferably conservative, amino acid substitutions, deletions, or insertions, in a naturally-occurring amino acid sequence which do not alter at least one essential property of said peptide, such as, for example, its biological activity. Such peptides may be synthesised by chemical peptide synthesis. Conservative amino acid substitutions are well-known in the art. For example, one or more amino acid residues of a native protein can be substituted conservatively with an amino acid residue of similar charge, size or polarity, with the resulting peptide retaining functional ability as described herein. Rules for making such substitutions are well known. More specifically, conservative amino acid substitutions are those that generally take place within a family of amino acids that are related in their side chains. Genetically-encoded amino acids are generally divided into four groups: (1) acidic=aspartate, glutamate; (2) basic=lysine, arginine, and histidine; (3) non-polar=alanine, valine, leucine, isoleucine, proline, phenylalanine, methionine, and tryptophan; and (4) uncharged polar=glycine, asparagine, glutamine, cysteine, serine, threonine, and tyrosine. Phenylalanine, tyrosine and tryptophan are also jointly classified as aromatic amino acids. One or more replacements within any particular group such as, for example, the substitution of leucine for isoleucine or valine are alternatively, the substitution of aspartate for glutamate or threonine for serine, or of any other amino acid residue with a structurally-related amino acid residue will generally have an insignificant effect on the function of the resulting peptide.

Included within the scope of the definition of a “peptide” are amino acid sequence variants that have undergone unnatural modifications such as but not limited to protection, carboxylation, and derivatization by amide and non-amide bonds as well as covalent and non-covalent modification.

Included in the scope of the definition of the term “peptide” is a peptide whose biological activity is predictable as a result of its amino acid sequence corresponding to a functional domain. Also encompassed by the term “peptide” is a peptide whose biological activity could not have been predicted by the analysis of its amino acid sequence.

The present invention is not limited by the source of the peptide, and clearly extends to peptides and peptide mixtures which are derived from a natural occurring or a non-natural source.

The term “peptide” also includes polypeptides, oligopeptides or shorter peptide sequences derived from a recombinant protein. The term “recombinant protein” as used herein shall be taken to refer to a recombinant protein. Protein which is produced in vitro or in a host cell by the expression of a genetic sequence encoding said protein, which genetic sequence is under the control of a suitable promoter, wherein a genetic manipulation has been performed in order to achieve said expression. Accordingly, the term “recombinant protein” clearly encompasses proteins produced by the expression of genetic sequences contained in viral vectors, cosmids or plasmids that have been introduced into prokaryotic or eukaryotic cells, tissues or organs. Genetic manipulations which may be used in this context will be known to those skilled in the art and include, but are not limited to, nucleic acid isolation, restriction endonuclease digestion, exonuclease digestion, end-filling using the Klenow fragment of E. coli DNA polymerase I to T4 DNA polymerase enzymes, blunt-ending of DNA molecules using T4 DNA polymerase or ExoIII enzymes, site-directed mutagenesis, ligation, and amplification reaction.

When the peptides of the present invention are derived from a recombinant protein, it may be produced in and, if desirable, isolated from a recombinant viral vector, expression system or host cell. As will be known to those skilled in the relevant art, a cell for production of a recombinant protein is selected on the basis of several parameters including the genetic constructs used to express the protein under consideration, as well as the stability and activity of said protein. It will also be known to those skilled in the art, that the stability or activity of a recombinant protein may be determined at least in part, by post-translational modifications to the protein such as, for example, glycosylation, acylation or alkylation reactions, amongst others, which may vary between cell lines used to produce the recombinant protein.

As used herein, the term “derived from” shall be taken to indicate that a particular peptide or mixture of peptides which has been obtained from a particular protein, protein mixture or protein-containing biological extract, either directly (for example, by proteolytic, chemical or physical digestion of the protein(s) or extract), or indirectly (for example, by chemical synthesis of peptides having amino acid sequences corresponding to naturally-occurring sequences, or peptide variants thereof).

The screening method of the present invention may be used to detect peptides having a wide range of target biological activities, including both agonist and antagonist activity. Target biological activities may relate to any human condition. By way of example only, target areas may include arterial and venous thrombosis, inflammation, angiogenesis and cancer, however the present invention is not restricted to screening in these target areas. Suitable screening assays include, but are not limited to, luminescence based assays to detect ATP released on activation of the platelets which are able to detect activators (agonists) or inhibitors (antagonists) of platelet activation, as well as coagulation assays for prothrombin time (PT) and activated partial thromboplastin time (APTT).

Preferably, in the method of the present invention, the initial library of peptides comprises a heterogeneous and unfractionated mixture of peptides derived from a precursor protein (or protein mixture or protein-containing biological extract) which provides a comprehensive range of potentially bioactive peptides.

Preferably also, the library is subjected to initial analysis or characterisation to provide information on the size and other characteristics of the component peptides, for example by matrix assisted laser desorption time of flight mass spectrometry (MALDI-ToF MS).

Initial screening of the library to confirm that it includes bioactive peptides may also be carried out using any suitable screening assay or assays, including but not limited to particular cell-based assays, to detect the predetermined biological activity or activities.

After the library has been confirmed as including bioactive peptides, it is fractionated by suitable means of fractionation including but not limited to chromatographic methods such as, but not limited to, size exclusion, ion exchange, hydrophobic interaction and/or reverse phase-high performance liquid chromatography, field-flow fractionation (including but not limited to sedimentation, flow, thermal and steric), and electrophoresis in order to provide fractions of the library for subsequent further screening. This further screening may be carried out by any suitable screening assay or assays as discussed above so as to identify an active fraction or active fractions which include bioactive peptides.

Since such active fractions are likely to include more than one peptide, each fraction may, if desired, be subjected to one or more further cycles of fractionation by suitable means of fractionation including but not limited to chromatography, field-flow fractionation (including but not limited to sedimentation, flow, thermal and steric), and electrophoresis to form sub-fractions, followed by screening of each sub-fraction as described above so as to identify an active sub-fraction or active sub-fractions which include bioactive peptides.

Each fraction or sub-fraction which is produced may also be subjected to analysis or characterisation as described above, for example by MALDI-ToF MS, so as to provide information on the size and other characteristics of the component peptides in the fraction or sub-fraction.

In accordance with the invention, one or more bioactive peptides are isolated from an active fraction or active sub-fraction using protein/peptide purification methods which are well known to persons skilled in this art, followed if desired by further bioassays to confirm the bioactivity of the isolated peptide(s).

Finally, peptides produced by the method of the present invention may also be displayed on a solid surface or membrane for subsequent screening in a relevant assay.

### BRIEF DESCRIPTION OF THE DRAWINGS

FIG. 1 is a schematic depiction of one embodiment of the process of the present invention for the detection of bioactive peptides for therapeutic and diagnostic use.

FIG. 2 shows by way of example the generation of digestion mixtures of the protein, fibrinogen.

FIG. 3 shows by way of example the chromatographic fractionation of fibrinogen digestion mixtures into libraries.

FIG. 4 shows by way of example the luminometric determination of ATP release from platelets in response to collagen in the presence or absence of RGDS.

FIG. 5 shows by way of example the luminometric determination of collagen-induced ATP release from platelets following co-incubation with fractionated fibrinogen-derived peptides.

FIG. 6 shows an example of a MALDI-ToF MS spectrum of a fraction from digests of fibrinogen.

FIG. 7 shows by way of an example a user interface for digest scouting. The scout includes the position on the digest MTP occupied by the digest mixture. “Sample transfer” is a function used to aliquot a small amount of sample from one MTP to another MTP. The remaining buttons refer to the preparation of a sample plate, for example the Anchorchip™ (Bruker Daltonics) sample plate.

FIG. 8 are graphs of Average mass vs Time at four values of pH. The graphs show pH 7.5-8.0 to be the most efficient, however, if a partial digest is desired, the digestion point can be picked from the graphs.

### DETAILED DESCRIPTION OF THE INVENTION

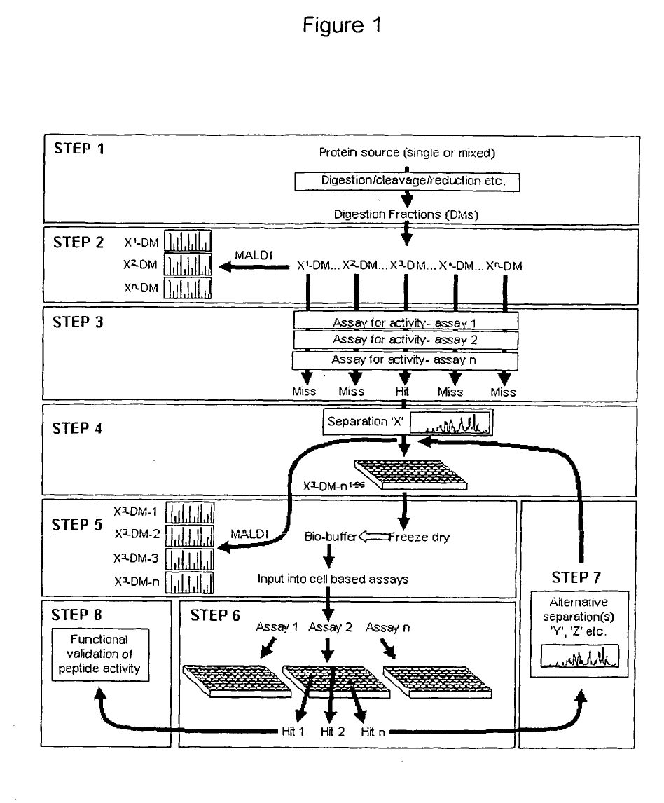

The scheme outlined below comprises one embodiment of the present invention for the generation, isolation and identification of bioactive peptides derived from proteins and protein mixtures (see also FIG. 1). This scheme involves:

Step 1 The digestion by, but not limited to, proteolytic, chemical or physical means, of single proteins and/or protein containing biological extracts to produce a digestion mixture (that is, a library of peptides).

Step 2 The biochemical characterization of the peptides contained within the digestion mixture.

Step 3 Screening of the digestion mixture for biological activities.

Step 4 Chromatographic fractionation of the digestive mixture into component peptide fractions.

Step 5 Assay of fractions for both peptide mass fingerprints and biological activity.

Step 6/7 Subsequent re-fractionation and assay of activity-containing fractions.

Step 8 The full identification and analysis of the bioactive peptide(s).

Taken together, these eight steps provide a process by which bioactive peptides may be detected from both simple and complex protein mixtures. Incorporated within the described method is the collection of peptide mass and abundance information at Steps 2, 4, 6 and 8 and detection of bioactivity at Steps 3, 5, 7 and 8, such that the precise identity and activity of an observed bioactive peptide can be determined.

When bio-active peptides are identified and biochemically characterised, analogues may be synthesized in whole or in part comprising both distinct and overlapping sequence coverage and each of these forms assayed for bio-activity so as to provide precise information as to the minimum active unit. Further, these peptides may be ligated through established methodologies to extraneous proteins and non-protein molecules such as carriers, toxins and immunoglobulins that may serve to optimally localise, target or modulate cells, targets or receptors to desired biological ends.

Bio-active peptides may be cross-linked or complexed by means including but not limited to dihydroxylysinonorleucine, hydroxylysinonorleucine or lysinonorleucine as well as non-reducible cross-links such as histidinohydroxylysinonorleucinepyridinoline, deoxypyridinoline and pentosidine. The generation of optimally active forms of detected bio-active peptides can thus be produced for putative therapeutic benefit.

Step 1.—Digestion of Protein(s)

The source protein may take any form; it may be single naturally expressed protein purified from a complex biological extract, or a recombinant (such as but not limited to bacterial, insect or mammalian expression systems) form of a specified protein. Alternatively, a complex protein mixture from biological fluids, tissue or cellular extracts may be used as the protein source. The protein may be cleaved into peptide components using, but not limited to, purified proteases, protease activity-containing extracts, chemical cleavage or other mechanism of protein fragmentation. The overall approach is to generate a library of peptides that comprises a heterogeneous and unfractionated mixture of peptides from the intact protein(s). Such a library can comprise partial, intermediate and/or complete digestions of the protein source thus providing as comprehensive a range of protein fragments as possible. A wide range of fragments can be achieved by varying a range of conditions including digestion times, pH, buffer and temperature conditions and substrate to enzyme ratios. Additionally, cleavage of the protein may be performed by a range of cleavage agents (including but not limited to protease and chemical cleavage) each having a defined and different protein cleavage specificity. Cleavage may also be performed either in series or in parallel, such that different combinations of these digestion methodologies can be used to generate distinct peptide species. Accordingly, each variation on a digestion condition will generate a distinct library of peptides from a particular protein source.

Preferably, a separate sample of the source protein is subjected to a method to monitor the extent or progress of cleavage. The method should be rapid and reliable while consuming minimal amount of sample.

By way of example only, an automated procedure using a MALDI-ToF MS instrument for measuring the mass of the resulting peptides and an X-Y pipeting workstation controlled by a PC for the delivery of reagents and the extraction of reactants enables the operator to determine the optimal digest parameters to thus obtain the optimal peptide profile for further downstream experiments.

The method consists of the following steps:
1. The protein to be cleaved is placed in several wells of a thermostated standard microtiter plate (MTP) at preset buffer conditions such as concentration and pH or other parameters relevant to the experiment in question.
2. The cleaving agent (ie. enzyme or chemical) is added to the wells at time zero.
3. Aliquots (typically a few μl) are removed and deposited to a second MTP preloaded with quenching agent, typically a solution of dilute acid. Several aliquots are taken at successive time points as programmed into the PC controlling the pipeting station software for the duration of the experiment. Exponentially increasing time points are set starting at 5 minutes (5, 10, 20, 40, 80, 160, 320, 640 and 1280 minutes—>20 h—etc.), however each time point can be set as required by the experiment in question. Unattended, round the clock experiments are within the scope of the method.
4. Following the extraction of digest mixture at each time point, the X-Y pipeting workstation creates a mirror image of the second microtiter plate on an Anchorchip™ target plate. The peptides are mixed with matrix, dried, washed and the matrix/sample mixture on each spot is recrystallised prior to MALDI-ToF MS analysis.
5. Mass spectra of all reaction mixtures are automatically recorded using the MALDI-ToF MS instrument.
6. The distribution of peptide masses measured will thus yield a ‘picture’ of the degree the cleavage has progressed. For example, the presence of intact protein or large peptides is indicative of incomplete cleavage.
7. In the case of any ambiguous results the second microtiter plate contains sufficient sample for confirmative analyses.

Classical monitoring of protein cleavage is performed using reversed phase HPLC where reduction in the peak corresponding to the protein and incremental increase in emerging peptide peaks is taken as an expression of the progress of the cleavage. However, the position of new emerging peptide peaks is hard to predict and although eluting time and peptide time may be correlated, it is far from an ideal method. Also, partial cleavages are hard to predict using HPLC based methodology. Furthermore, although the eluted peptides may be collected and recycled, in practice, the HPLC based method requires nanomoles or a few micrograms of protein sample which is often unrecoverable.

The proposed MALDI-ToF MS method consumes low to sub picomole amount of sample or—for a medium size protein of 50 kDa.—a few nanograms per analysis. A modern MALDI-ToF MS instrument is able to analyse at least a hundred samples in automatic mode as soon as the sample is spotted onto the sample or target plate and the plate is loaded into the instrument. Many advanced instruments can load several thousands of samples for automatic analysis. A conservative estimate of the analysis time for a MALDI-ToF MS measurement is thus the sum of the target preparation time plus the time of each mass analysis. The setup in this proposal allows most of the target preparation to happen during the digest and hence the target preparation time may be as short as ten minutes and each sample can typically be analysed in less than 20 seconds.

Step 2.—Selection of Digestion Conditions

Unfractionated peptide libraries may be subjected to analysis, including but not limited to mass spectometry, an example of which is matrix assisted laser desorption time of flight mass spectrometry (MALDI-ToF MS); this analysis provides precise information on the size and possible identity of the component peptides. In the case of MALDI-ToF MS analysis, spectra for a number of libraries may be compared and optimal sets of digestion condition parameters determined where marked changes in peptide profile (number/size/pattern complexity etc.) occur. These sets of digestion condition parameters can be used to generate predictable ‘hot-spots’ where digestion should be focussed to limit the number of libraries for subsequent fractionation. In addition, these MALDI-ToF MS spectra provide an exact record of the profile of each library of peptides, providing both a level of quality control and allowing the generation of reproducible preparations for down stream analysis in cases where cellular activity assays identify “hits” for bioactive peptides in the library of peptides.

Step 3.—Identification of Fractions Containing Bioactivity

To reduce the number of libraries to be fractionated and screened, whole unfractionated digestion mixtures are preferably subjected to initial bioassays, including cell-based assays (refer FIG. 1). This step then precedes fractionation and bioactive peptide identification and allows identification of digestion mixtures for fractionation, thus reducing the number of fractionations required for the identification of each bioactive peptide. It should be noted that the ‘usefulness’ of a digestion mixture as determined by ‘bioactivity’ is dependent on the bioactivity assay used, and an apparently uninteresting digestion mixture may become interesting if it is positive when used as an input in a new assay. In addition, the co-existence of an agonist peptide and an antagonist peptide in a single digestion mixture may cancel each other out so that together there may be no net bioactivity in any particular assay, however, after fractionation, such activities may manifest themselves when separate fractions are assayed for bioactivity.

High throughput, automated screening assays are preferably used to identify potential bioactivities with relevance to several major therapeutic applications. The library of peptides may be subjected to a wide array of both biochemical and cell-based assays, providing extremely wide scope for potential hits in multiple target areas. By way of example only, initial high throughput screens may consist of luminescence based assays for platelet activation, laser-based methods for Prothrombin Time (PT) and Activated Partial Thromboplastin Time (APPT), luminescence and fluorescence based detection of cell proliferation, cell toxicity and apoptosis and in vivo assays. In all cases, each library may be screened for agonist and antagonist actions, thus providing the potential to identify bioactive peptides and develop activities that may have either therapeutic or diagnostic value.

Step 4.—Initial Fractionation of Digestion Mixtures

Each library of peptides found to contain a biological activity in Step 3 is then fractionated by chromatographic methods including but not limited to, size exclusion, ion exchange, hydrophobic interaction and/or reverse phase-high performance liquid chromatography. To interface directly with the biological screening assays detailed in Step 3, fractions (for example 2 ml in the first instance) are preferably collected in a format that is compatible with direct robot driven transfer into the assays for biological activity outlined in step 3. While not restricted to any particular format, use of 96 deep-well plates is preferred as the aim, wherever possible, is to use chromatographic solvents that will be either compatible with subsequent bioassays or suitable for freeze-drying. At this point the collected fractions may be freeze-dried and stored. When required, the freeze-dried material can be resuspended in a cell-compatible isotonic and buffered solution.

Step 5.—Assay of Collected Fractions for Both Analysis and Biological Activity.

Using either a split flow system, or by direct analysis of an aliquot taken from the collected fractions, a comprehensive data set may be collected on the composition of the component peptides in each fraction (mass spectrometry), thus each fraction has a unique finger print which can be used to match activity with mass. The collected fractions are also subjected to a range of cell-based or other activity assays as described in step 3 in order to identify fractions containing biological activity (i.e. active fractions).

Step 6/7—Subsequent Re-Fractionation and Assay of Activity-Containing Fractions.

Since active fractions identified in step 5 are likely to contain more than one peptide, the fractions are preferably subjected to one or more further rounds of chromatography (second and subsequent dimensions) to form sub-fractions, with each round involving monitoring of the composition of each sub-fraction by MALDI-ToF MS, and identification of active sub-fractions using activity assays as described in step 3.

Step 8.—The Full Identification and Analysis of the Bioactive Peptide(s).

Any peptide moiety found to have agonist and/or antagonist activities in the cell-based or other bio-assay(s) performed in step 5 is subjected to further analysis. Peptide sequence identification of a given putative bioactive peptide can be achieved through a combination of MALDI-ToF MS—post source decay—MS data and alignments to the Human Genome Database. Putative bioactive peptides can be validated by synthesising analogues and substitution/sequence-reversal variants and examining their ability to replicate the initial agonist/antagonist activities initially observed in the cell-based or other assays performed in Step 5. Finally, active peptides may be subjected to further evaluation in more sophisticated (tissue/organ/whole animal) bioassays.

The following Examples are provided in order to assist in a full and complete understanding of the method of the present invention. It is to be understood that the invention is not to be limited in scope by these Examples, but extends broadly to the detection of bioactive peptides derived from a precursor protein or protein-containing biological extract as described above.

### EXAMPLE 1

This Example describes the generation, identification and activity of expected RGD-containing anti-thrombotic peptides in proteolytic digests of the purified protein, fibrinogen, as “proof of concept” of the method of the present invention.

Fibrinogen is an α2β2γ2 heterodimeric plasma glycoprotein, which has multifunctional roles in regulating thrombosis. It bridges the interaction between aggregating platelets through an internal arginine-glycine-aspartic acid (RGD) sequence, which binds to the platelet aggregation receptor, the integrin GP IIb-IIIa. Proteolytic fragments of fibrinogen, particularly peptides containing the RGD motif, are therefore predicted to antagonise several of the anti-thrombotic screening assays.

To liberate the expected RGD-containing fibrinogen fragments, a library of partial and complete Lys-C- and trypsin-digested fragments was generated. A range of digestion products were generated by varying digestion condition parameters, and the resulting digestion mixture fractionated by reversed phase high performance chromatography to form a digest library for screening.

Miniaturised (96 well format) high-throughput screening assays capable of assessing platelet activation that are suitable for screening potential anti-thrombotic agents have been developed. The primary assay is based on the phenomenon that platelet activation results in a substantial release of ATP from dense granules. Released ATP is then rapidly quantitated in a plate reader using bioluminescence and is proportional to the extent of platelet activation.

The identity of the peptides was established by comparing peptide masses measured by MALDI-ToF MS to a list of values obtained from a theoretical digest of fibrinogen. The mass accuracy achieved by using a reflector instrument was within 100 ppm, resulting in a very high degree of certainty of the peptide identification and integrity. Any remaining ambiguities of the peptide identity can be eliminated by fragment analysis using the same instrument.

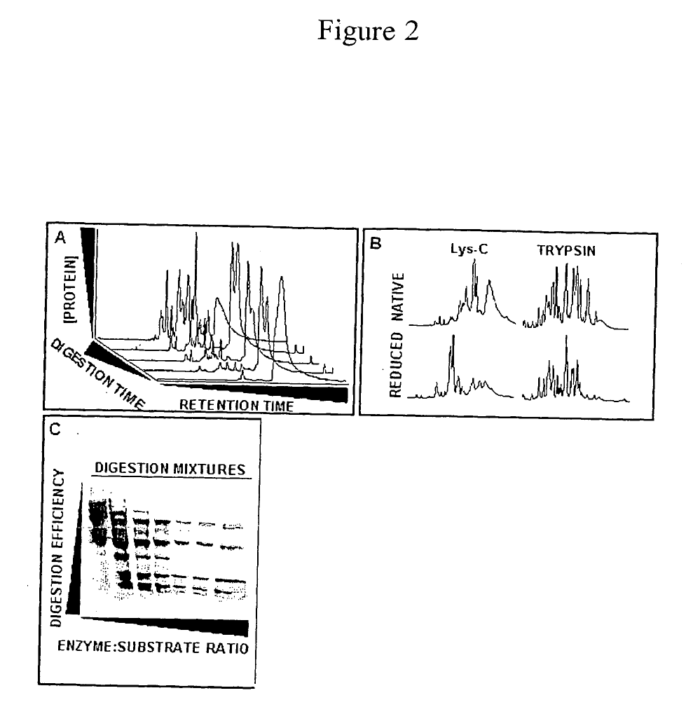

FIG. 2 shows by way of example the generation of fibrinogen digestion mixtures. Fibrinogen was protease-digested under various conditions to generate a range of partial and complete digest products and mixtures. These digestion mixtures individually and in combination are constituted of a diverse range of complete and partially digested peptides of different amino acid sequences. Such a process has the capacity to reveal cryptic peptides not otherwise detected in nature. Some of these conditions are described below: (A) fibrinogen was treated with Lys-C over a range of times to generate a heterogeneous mixture of full and partial digest products; (B) fibrinogen, in both reduced and non-reduced forms, was digested with Lys-C and trypsin to produce a range of unique and distinct peptide species; (C) fibrinogen was digested with Lys-C at various enzyme to substrate ratios to produce a range of digested peptide species.

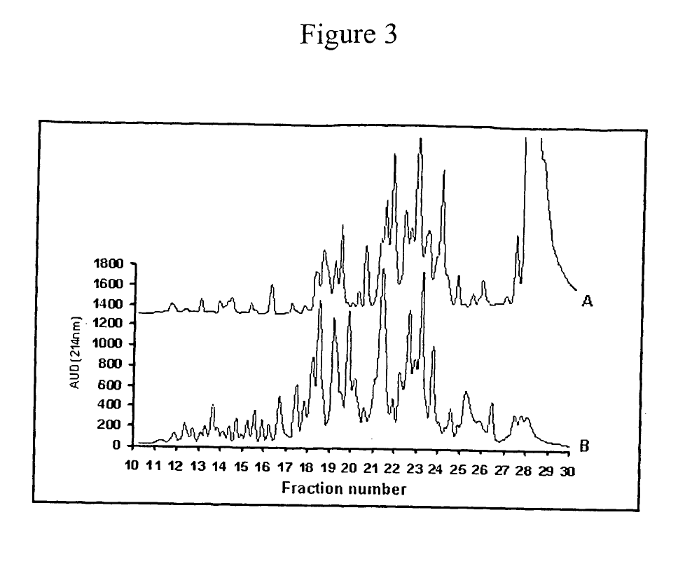

FIG. 3 shows by way of example chromatographic fractionation of digestion mixtures into digest libraries of peptides. Fibrinogen was protease-digested with Lys-C or trypsin at a substrate to enzyme ratio of 1:100 for 16 hrs. These digestion mixtures were chromatographically separated by Reversed Phase-HPLC using a C18 (5μ, 2.0×150 mm) column using an eluent of ACN (0-100% ACN in 30 min with 0.1% TFA) at 0.5 mL/min and collected in 250 μL fractions. An aliquot of each library fraction was kept for mass spectrometric analysis and the balance dried and stored at −80° C.

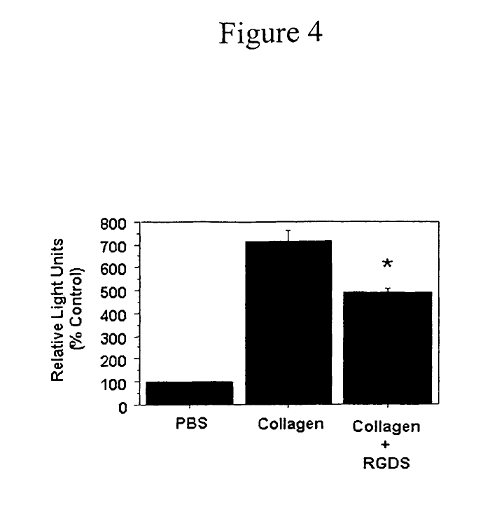

FIG. 4 shows by way of the luminometric determination of ATP release from platelets in response to collagen. Platelet rich plasma was stimulated by automated injection of 2 μg/ml collagen in the presence or absence of commercially available RGDS (30 μM). Relative light output was then measured automatically in a BMG Fluostar plate reader. RGDS partially inhibited collagen-induced ATP release by 30% (*: p<0.002 versus collagen alone).

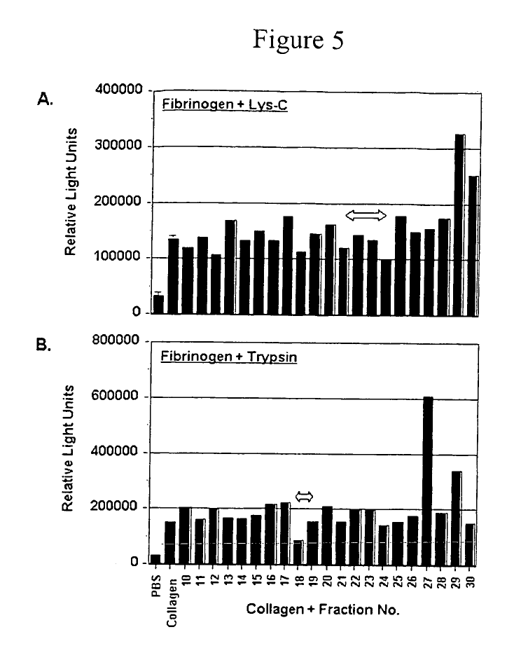

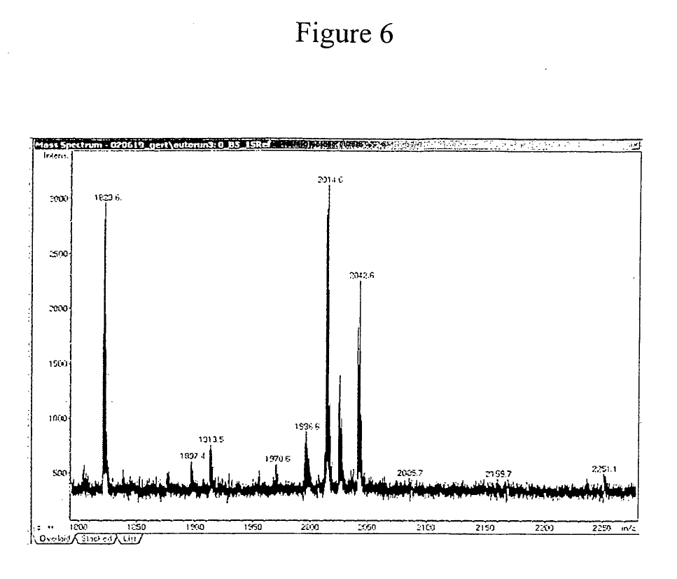

FIG. 5 shows by way of the luminometric determination of collagen-induced ATP release from platelets (see FIG. 4) following coincubation with fractionated fibrinogen-derived peptides. Fibrinogen was digested with either Lys-C (A) or trypsin (B) prior to fractionation as described in FIGS. 2 and 3. The fractions highlighted by horizontal arrows partially inhibited collagen-induced ATP release and were shown by MALDI-ToF MS to comprise RGD containing peptide species (see FIG. 6). In addition, several fractions (29, 30 in A; 27, 29 in B) were shown to enhance collagen-induced ATP release, demonstrating that both agonist and antagonist activities can be identified after fractionation.

FIG. 6 is an example of a MALDI-ToF MS spectrum of a fraction from digests of fibrinogen. The spectrum was obtained using the Anchorchip method developed by Bruker-Daltonics. In short, an aliquot of 0.25 μl of sample is mixed with 0.25 μl of alpha-cyano cinnamic acid prior to deposition on the Anchorchip plate which locates the sample to a 400 μm spot. The spectrum was recorded using an Autoflex (Bruker-Daltonics) mass spectrometer run in an automatic mode. The peak at 2042.6 corresponds to the second isotope of the RGDS containing peptide alpha chain 547-564. The insert shows the isotopic peaks and indicates the high mass accuracy obtained.

### EXAMPLE 2

This example describes a method for the determination of optimal condition for either enzyme or chemical cleavage of proteins using MALDI-ToF MS

A Bovine Serum Albumin (BSA) tryptic digest was prepared at four different pH values (7.0, 7.5, 8.0 and 8.5) and aliquots were sampled at six time points (5, 10, 20, 40, 80 and 160 minutes).

The robotic system was an 8 channel X-Y robot based on a Gilson 215 with automatic file transfer to the Bruker Daltonics Autoflex MALDI-ToF MS. A thermostated microtiter plate (MTP) holder was added to the robot to optimise the digest in the MTPs. An Excel macro was developed to control the robot in terms of where to aspirate and dispense the sample and when to perform the action. Prior to the digest commencing 5 μl of 1% formic acid was dispensed into each well of the target MTP to stop digestion when an aliquot of digest mixture was deposited into the well.

Spotting of the MALDI-ToF MS target plate was performed using a Bruker Daltonics developed script.

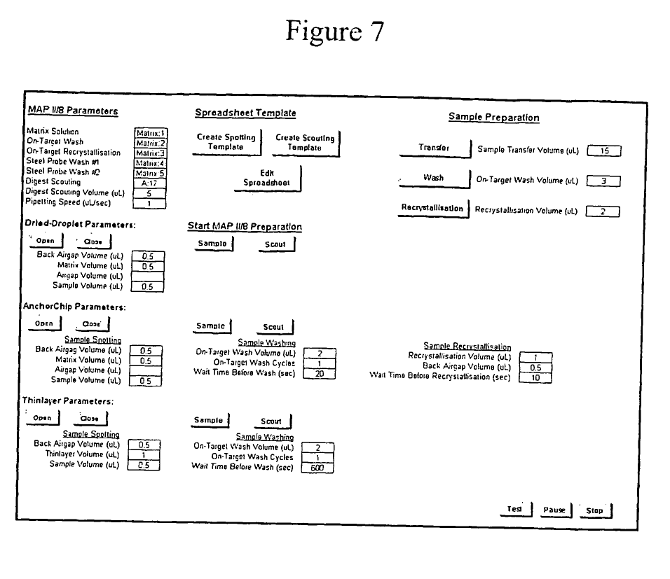

FIG. 7, shows by way of an example a user interface for digest scouting. The scout includes the position on the digest MTP occupied by the digest mixture. “Sample transfer” is a function used to aliquot a small amount of sample from one MTP to another MTP. The remaining buttons refer to the preparation of a sample plate, for example the Anchorchip™ (Bruker Daltonics) sample plate.

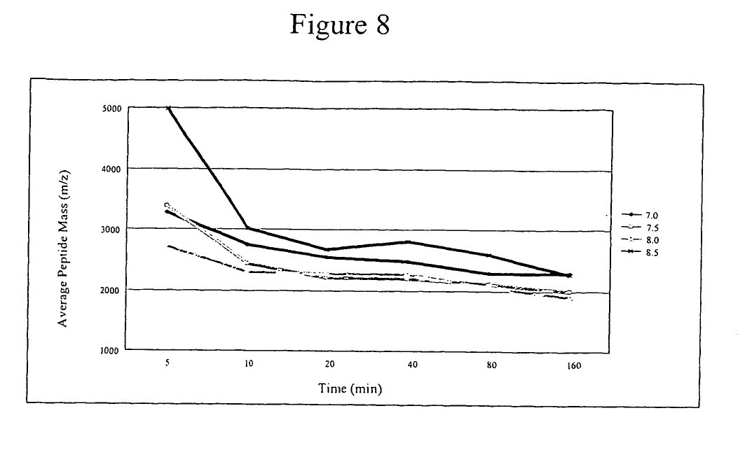

Furthermore, an Excel spreadsheet was developed for data evaluation. Several options for evaluation of the recorded spectra have been tested and it has been found that monitoring the appearance of peptides of mass lower than 5 kDa is the optimal method. As opposed to measuring all the digest products (including peptides above 5 kDa) the monitoring of smaller peptides is reproducible and robust in automatic acquisition mode. This is based on the assumption that the further a digest progresses, the more bonds will be cleaved and hence the lower the average mass of the peptides. This average peptide mass can be plotted against time as seen in FIG. 8. FIG. 8 shows graphs of average mass vs time at four values of pH. The graphs show pH 7.5-8.0 to be the most efficient, however, if partial digests are desired, the digestion time point can be picked from the graph.

1: A method for the detection of bioactive peptides derived from a precursor protein or protein-containing biological extract, comprising the steps of:
(i) providing a library of peptides derived from said precursor protein or protein-containing biological extract;
(ii) optionally screening said library to confirm that it includes peptides exhibiting one or more biological activities;
(iii) separating said library to provide fractions of the library;
(iv) screening said fractions to identify active fractions which include peptides exhibiting said one or more biological activities;
(v) optionally separating each said active fraction to provide sub-fractions thereof, and screening said sub-fractions to identify active sub-fractions which include peptides exhibiting said one or more biological activities; and
(vi) isolating from said active fractions or active sub-fractions one or more peptides exhibiting said one or more biological activities.

2: The method according to claim 1, wherein said library of peptides is derived by enzymatic cleavage of the precursor protein or protein-containing biological extract.

3: The method according to claim 1, wherein said library of peptides is derived by chemical cleavage of the precursor protein or protein-containing biological extract.

4: The method according to claim 1, wherein said library of peptides is derived by physical digestion of the precursor protein or protein-containing biological extract.

5: The method according to claim 1, wherein said precursor protein or protein-containing biological extract, or said unfractionated peptide library, is subjected to a determination of optimal cleavage conditions by monitoring the extent or progress of cleavage or digestion.

6: The method according to claim 5, wherein said determination comprises mass spectometry analysis.

7: The method according to claim 6, wherein said determination comprises MALDI-ToF MS analysis.

8: The method according to claim 6, wherein said determination is automated.

9: The method according to claim 1, wherein said library of peptides is provided by chemical synthesis.

10: The method according to claim 1, wherein said peptides comprise at least 2 amino acids.

11: The method according to claim 9, wherein said peptides comprise at least 5 amino acids.

12: The method according to claim 1, wherein said peptides are peptide variants.

13: The method according to claim 1, wherein said peptides are peptide variants.

14: The method according to claim 1, wherein said peptides comprise peptides whose biological activity is not predictable by amino acid sequence analysis.

15: The method according to claim 1, wherein said precursor protein is naturally occurring protein.

16: The method according to claim 1, wherein said precursor protein is a non-naturally occurring protein.

17: The method according to claim 1, wherein said precursor protein is a recombinant protein.

18: The method according to claim 1, wherein said biological activity is agonist activity.

19: The method according to claim 1, wherein said biological activity is antagonist activity.

20: The method according to claim 1, wherein said biological activity relates to any human condition.

21: The method according to claim 20, wherein said biological activity relates to conditions selected from the group consisting of arterial and venous thrombosis, inflammation, angiogenesis and cancer.

22: The method according to claim 1, wherein said screening of step (ii) and/or step (iv) is carried out using an assay selected from the group consisting of biochemical-based assays and cell-based assays.

23: The method according to claim 22, wherein said assay is selected from the group consisting of luminescence based assays for platelet activation, laser-based methods for Prothrombin Time and Activated Partial Thromboplastin Time, luminescence and fluorescence based detection of cell proliferation, cell toxicity and apoptosis and in vivo assays.

24: The method according to claim 22, wherein said assay is high throughput and automated.

25: The method according to claim 1, wherein said fractionation of step (iii) and/or step (v) is carried out by a fractionation method selected from the group consisting of chromatography, field flow fractionation and electrophoresis.

26: The method according to claim 25, wherein said fractionation of step (iii) and/or step (v) is carried out by chromatography.

27: An isolated peptide exhibiting one or more biological activities, which as been detected by the method according to claim 1.

28: The method according to claim 1, substantially as hereinbefore described with reference to the examples and/or figures.
